(19) United States
(12) Patent Application Publication
(10) Pub. No.: US 2018/0198120 A1
(43) Pub. Date: Jul. 12, 2018

(54) LITHIUM SECONDARY BATTERY

(71) Applicants: Tokyo Metropolitan University, Tokyo (JP); 3DOM Inc., Yokohama (JP)

(72) Inventors: Masaaki KUBOTA, Fukushima (JP); Hidetoshi ABE, Fukushima (JP); Miyu NEMOTO, Fukushima (JP); Kiyoshi KANAMURA, Tokyo (JP); Kazuhiro IMAZAWA, Kanagawa (JP)

(73) Assignees: Tokyo Metropolitan University, Tokyo (JP); 3DOM Inc., Yokohama (JP)

(21) Appl. No.: 15/740,284

(22) PCT Filed: Apr. 28, 2016
(86) PCT No.: PCT/JP2016/063442

§ 371 Date: Dec. 27, 2017

(30) Foreign Application Priority Data
Jul. 1, 2015 (JP) 2015-132929

(51) Int. Cl. H01M 4/36; H01M 10/052; H01M 4/485; H01M 4/58; H01M 4/50; H01M 2/16

(52) U.S. Cl. CPC H01M 4/364; H01M 10/052; H01M 4/485; H01M 2004/028; H01M 4/502; H01M 2/16; H01M 4/5825

(57) ABSTRACT

A lithium secondary battery having a positive electrode, a negative electrode, a separator and an electrolyte solution, in which the positive electrode contains a first active material and a second active material each capable of intercalating and deintercalating lithium. The first active material is in the state under which only deintercalation of lithium can be carried out in a battery reaction with the negative electrode immediately after assembly of the lithium secondary battery, and the second active material is in the state under which lithium can be intercalated in the battery reaction with the negative electrode immediately after assembly of the lithium secondary battery. The negative electrode contains metal lithium as an active material. The separator has a structure in which pores are three-dimensionally regularly arranged.

### CROSS-REFERENCE TO RELATED APPLICATIONS

This application is a U.S. National Stage Application which claims the benefit under 35 U.S.C. 371 of International Application No. PCT/JP2016/063442, filed Apr. 28, 2016, which claims the foreign priority benefit under 35 U.S.C. § 119 to Japanese Patent Application 2015-132929, filed Jul. 1, 2015, the entire contents of which are incorporated herein by reference.

### TECHNICAL FIELD

The present invention relates to a lithium secondary battery, and particularly, relates to a lithium secondary battery using metal lithium as a negative-electrode active material.

### BACKGROUND ART

Lithium secondary batteries have been widely used for the reason that they have, e.g., a high energy density and installed in small portable electronic devices such as mobile phones, digital cameras and notebook computers, as a power source. Lithium secondary batteries, in view of e.g., energy resource depletion and global warming, are being developed as a power source for hybrid cars or electric cars or as a power storage source for natural energy such as sun light and wind power. To increase the use of these power sources, it is required that lithium secondary batteries have a further higher capacity and a longer life.

Such a lithium secondary battery is charged and discharged by moving lithium ions between a positive electrode and a negative electrode. As a positive-electrode active including lithium, such as, lithium cobaltite (LiCoO₂), lithium manganate (LiMn₂O₄), lithium nickelate (LiNiO₂) and lithium iron phosphate (LiFePO₄), are presently put into practical use or under development for commercialization.

As a negative-electrode active material, a carbon material such as graphite and lithium titanium oxide (Li₄Ti₅O₁₂) are used. Between a positive electrode and a negative electrode containing the corresponding active materials as mentioned above, a separator for preventing an internal short circuit is interposed. As the separator, a microporous thin film usually formed of a polyolefin is used.

Of the negative-electrode active materials, metal lithium has a characteristic that the electric quantity per unit weight is as large as 3.86 Ah/g. Because of this, in order to accomplish a high-capacity lithium secondary battery having the highest theoretical energy density, studies are being now newly conducted for using metal lithium as a negative-electrode active material.

However, a lithium secondary battery using metal lithium as a negative-electrode active material has a problem in that lithium grows like a dendrite, from a surface of the negative electrode formed of metal lithium, when a charge and discharge cycle is repeated, and lithium grown like a dendrite punches through the separator interposed between a positive electrode and a negative electrode, and reaches the positive electrode to cause an internal short circuit.

In view of the foregoing, for example, Japanese Patent Laid-Open No. H4-206267 discloses a non-aqueous electrolyte solution secondary battery using LiCoO₂ as a main active material for a positive electrode and an initially dischargeable material (for example, manganese dioxide) as a sub active material.

In the publication (upper left column, page 2), a mechanism of growing a lithium dendrite is described. There are two main factors for dendritic growth. The first one is that an inert coating of e.g., lithium carbonate or lithium hydroxide is formed on a metal lithium surface of the negative electrode, immediately after assembly of a battery. The second one is that when lithium cobalt oxide (LiCoO₂) is used as a positive electrode active material, a charge/discharge cycle starts from charging. During the initial charging time, lithium ion (Li⁺) released from the positive electrode is reduced into lithium and deposited on a metal lithium surface of a negative electrode. For the reason, the inert coating formed on the metal lithium surface of the negative electrode cannot be removed. If the inert coating on the metal lithium surface of the negative electrode is not removed, lithium is non-uniformly deposited on the metal lithium surface of the negative electrode. As a result, lithium deposited on the negative electrode surface grows like a dendrite during the following charging time in the charge/discharge cycle, pierces the separator and reaches the positive electrode to cause an internal short circuit.

In the publication, as a positive electrode active material, not only LiCoO₂ serving as a main active material but also an initially dischargeable material (for example, manganese dioxide) as a sub active material is used. Because of this, discharge can be performed at the initial time of charge/discharge. In other words, lithium can be released as a lithium ion from the metal lithium of a negative electrode. Owing to release of lithium, the inert coating of e.g., lithium carbonate or lithium hydroxide, formed on the metal lithium surface of a negative electrode of a battery immediately after assembly of a battery can be removed. As a result, a lithium ion is reduced and deposited on the metal lithium surface in good condition of the negative electrode, during the charging time after the initial discharging. Because of this, dendritic lithium growth from the metal lithium surface of the negative electrode can be suppressed.

### DISCLOSURE OF THE INVENTION

However, the invention described in the publication is only concerned with starting the charge/discharge cycle immediately after battery assembly from discharging, and thus, release behavior of lithium ion from metal lithium of a negative electrode, during the initial discharging time, is not precisely investigated. Because of this, lithium dendrite growth from metal lithium of a negative electrode cannot be necessarily and sufficiently suppressed or prevented.

An object of the present invention is to provide a lithium secondary battery having a high capacity and excellent charge/discharge cycle characteristics while suppressing or preventing lithium dendrite growth.

According to an embodiment, to attain the above object, there is provided a lithium secondary battery having

a positive electrode, a negative electrode, a separator and an electrolyte solution, in which

the positive electrode contains a first active material and a second active material each capable of intercalating and deintercalating lithium, the first active material being in the state under which only deintercalation of lithium can be carried out in a battery reaction with the negative electrode immediately after assembly of the lithium secondary battery, and the second active material being in the state under which lithium can be intercalated in the battery reaction with the negative electrode immediately after assembly of the lithium secondary battery,

the negative electrode contains metal lithium as an active material, and

the separator has a structure in which pores are three-dimensionally regularly arranged.

According to such a construction, it is possible to provide a lithium secondary batter having a high capacity and excellent charge/discharge cycle characteristics while suppressing or preventing lithium dendrite growth by the function described in detail later.

### BRIEF DESCRIPTION OF DRAWING

FIG. 1 is a sectional view showing a lithium secondary battery according to the embodiment.

### DESCRIPTION OF EMBODIMENT

Now, an embodiment of the present invention will be more specifically described.

The lithium secondary battery according to the embodiment has a positive electrode, a negative electrode, a separator and an electrolyte solution. The positive electrode contains a first active material and a second active material each capable of intercalating and deintercalating lithium. The first active material is in the state under which only deintercalation of lithium can be carried out in a battery reaction with the negative electrode immediately after assembly of the lithium secondary battery, more specifically, the initial time of the charge/discharge cycle. The second active material is in the state under which lithium can be intercalated in a battery reaction with the negative electrode immediately after assembly of the lithium secondary battery, more specifically, the initial time of the charge/discharge cycle. The negative electrode contains metal lithium as an active material and the separator has a structure in which pores are three-dimensionally regularly arranged.

According to the embodiment, it is possible to provide a lithium secondary battery having highly reliable and excellent charge/discharge cycle characteristics while suppressing or preventing lithium dendrite growth from a negative electrode in the charge/discharge cycle of a lithium secondary battery using metal lithium as a negative electrode active material, thereby preventing an internal short circuit between the positive electrode and the negative electrode caused by the lithium dendrite growth. Also, a lithium secondary battery having a high capacity can be provided by using metal lithium as an active material for the negative electrode.

In a lithium secondary battery having a positive electrode, a separator, a negative electrode containing metal lithium as an active material and an electrolyte solution, lithium is grown like a dendrite from the metal lithium surface of the negative electrode in the charge/discharge cycle based on the following mechanism.

More specifically, in the lithium secondary battery having the aforementioned structure, the positive electrode contains an active material (for example, LiCoO₂) in a state (completely discharged state) under which it can deintercalate lithium in a battery reaction with a negative electrode immediately after assembly of a lithium secondary battery, more specifically, at the initial time of the charge/discharge cycle. Because of this, at the initial time of the charge/discharge cycle, a charging step between the positive electrode and the negative electrodes is first started. During the charging time, lithium in a positive electrode active material (for example, LiCoO₂) is separated and ionized. The lithium ion passes through pores of a separator impregnated with an electrolyte solution and moves to a negative-electrode side. The lithium ion further moves from the electrolyte solution to the metal lithium surface of the negative electrode and is reduced and deposited on the surface. At this time, on the metal lithium surface, an inert coating of e.g., lithium carbonate or lithium oxide, is formed. Because of this, lithium tends to non-uniformly deposit on the surface of the metal lithium of a negative electrode. More specifically, lithium does not dispersedly deposit on the metal lithium surface but locally and disproportionately deposits. As a result, when lithium deposits on the metal lithium surface of the negative electrode during the next charging time after the first charge/discharge time, lithium grows like a dendrite from the site where lithium locally deposited, which acts as a point from which dendrite grows. Lithium dendrite growth is accelerated in the following charge/discharge cycle. Thus, the lithium dendrite grows, pierces the separator and reaches to the positive electrode and causes an internal short circuit.

In the lithium secondary battery according to the embodiment, the positive electrode contains a first active material and a second active material each capable of intercalating and deintercalating lithium as a positive-electrode active material. The first active material is in a state under which lithium can be deintercalated in a battery reaction with a negative electrode immediately after assembly of a lithium secondary battery; whereas, the second active material is in a state under which lithium can be intercalated in a battery reaction with a negative electrode immediately after assembly of a lithium secondary battery. Because of this, the second active material in the state under which lithium can be intercalated in the battery reaction with the negative electrode limits proceeding of the battery reaction. In short, the initial charge/discharge cycle is started from discharging. During the initial discharging time, an active material for a negative electrode; i.e., metal lithium is deintercalated and ionized. The lithium ion passes through a separator impregnated with an electrolyte solution and moves to a positive-electrode side. The lithium ion moved is taken up and intercalated by a second active material of the positive electrode.

During the initial discharging time as mentioned above, lithium is deintercalated (released) as a lithium ion from the metal lithium surface of a negative electrode. In the release of lithium from the metal lithium surface of the negative electrode, since a separator arranged so as to face the negative electrode has a structure formed of many pores three-dimensionally and regularly arranged, lithium is released from many sites (many points) of the metal lithium surface facing many pores of the separator regularly arranged. At this time, in many sites on the metal lithium surface from which lithium is released, micropores having a certain depth are regularly opened. It was confirmed, in a SEM photo of a metal lithium surface, that the micropores have a certain depth and are regularly formed. The micropores having a certain depth and being regularly formed are a phenomenon observed for the first time, resulting from the combination of performing initial discharge and use of a separator having many pores three-dimensionally and regularly arranged. Further, the inert coating on the metal lithium surface is desrupted and removed by release of lithium from the metal lithium surface, with the result that the surface modification is achieved in which the metal lithium surface is uniformly activated.

During the charging time after the initial discharging, the first active material, i.e., lithium, in the state, under which lithium can be released by the battery reaction with a negative electrode, is mainly ionized. The lithium ion passes through many pores three-dimensionally and regularly arranged of the separator impregnated with an electrolyte solution and moves to a negative-electrode side. Lithium ion further moves from the electrolyte solution to the metal lithium surface of the negative electrode, and is reduced and deposited on the surface.

Surprisingly, lithium does not deposit over the entire metal lithium surface of a negative electrode during the reduction deposit time but preferentially deposit in micropores having a certain depth and being regularly opened in the metal lithium surface. During the subsequent discharging time of the charge/discharge cycle, lithium deposited in many micropores in the metal lithium surface is preferentially released and the micropores are opened again. During the next charging time, a lithium ion is reduced and preferentially deposited in the many micropores. Likewise, many micropores having a certain depth are opened in the metal lithium surface of a negative electrode during the discharging time; whereas, lithium is reduced and preferentially deposited in the micropores during the charging time. In the reduction/deposition time after many micropores are completely closed, opening sites of many micropores work as sites for reduction/deposition of lithium during the charging time. As a result, lithium ion dissolved in the electrolyte solution does not deposit locally and disproportionately on the metal lithium surface but deposits dispersedly in opening sites of many micropores. For the reason, even if lithium grows like dendrites at the sites for reduction/deposition, since a predetermined amount of lithium reduced and deposited on the negative electrode surface during the charging time, the points from which a dendrite grows can be widely dispersed. In this manner, the frequency of dendritic growth can be significantly reduced.

Accordingly, in the lithium secondary battery according to the embodiment, lithium dendrite growth in a long-term charge/discharge cycle, accompanying an internal short circuit between a positive electrode and a negative electrode can be effectively prevented. Thus, metal lithium having a characteristic that an electric quantity per unit weight as large as 3.86 Ah/g can be safely used as a negative-electrode active material. As a result, highly reliable and high-performance lithium secondary battery having a high capacity and excellent charge/discharge cycle characteristics can be provided.

Now, individual components of the lithium secondary battery will be described.

<Positive Electrode>

The positive electrode has a positive electrode current collector and a positive electrode layer containing a positive-electrode active material formed on one or both surfaces of the positive electrode current collector.

As the positive electrode current collector, a metal plate or a metal foil can be used. The metal plate or metal foil is preferably formed of a material which does not vaporize or decompose under influence of heat, for example, metal such as aluminum, titanium, iron, nickel, copper or an alloy thereof.

The positive-electrode active material contains a first active material and a second active material each capable of intercalating and deintercalating lithium. In the embodiment, the positive-electrode active material consists of the first active material and the second active material.

As the positive-electrode active material containing the first active material and the second active material, the following two forms are mentioned.

1) the first active material and the second active material are lithium-containing compounds. The first active material is a lithium-containing compound capable of deintercalating lithium in a battery reaction with a negative electrode immediately after assembly of a lithium secondary battery, more specifically, at the initial time of the charge/discharge cycle. The second active material is a lithium-containing compound from which lithium is partially removed and capable of intercalating lithium in a battery reaction with a negative electrode immediately after assembly of a lithium secondary battery, more specifically, at the initial time of the charge/discharge cycle. Examples of the lithium-containing compounds of both cases include lithium containing metal oxides such as lithium cobalt oxide, lithium manganese oxide, lithium nickel oxide and lithium vanadium oxide or lithium-containing metal phosphorus oxides such as lithium phosphate.

The lithium-containing compounds serving as the first active material and second active material include Form a) where the elements constituting lithium-containing compounds are mutually the same and Form b) where at least one element except lithium of the elements constituting lithium-containing compounds are mutually different, may be mentioned.

In Form a), the first active material and second active material are both a lithium-containing metal oxide or a lithium-containing metal phosphorus oxide mentioned above consisting of the same elements. More specifically, the first active material is a lithium-containing metal oxide or a lithium-containing metal phosphorus oxide having a stoichiometric composition and the second active material is a lithium-containing metal oxide or a lithium-containing metal phosphorus oxide having a composition of the stoichiometric composition minus lithium. It is defined that the removal amount of lithium (Li) varies depending upon the type and addition amount of second active material.

To explain by way of example, the first active material and second active material both are lithium cobalt oxide constituted of the same elements; for example, the first active material is represented by a chemical formula: LiCoO₂ and the second active material is represented by a chemical formula: Li₁₋ₓCoO₂ where x represents the amount of lithium (Li) removed from the lithium cobalt oxide; and x preferably satisfies 0<x<0.6 and more preferably 0.1≤x≤0.5.

The second active material represented by a chemical formula: Li₁₋ₓCoO₂ for Form a) can be obtained, for example, by the following method.

More specifically, to the active material represented by LiCoO₂, a conductive material and a binding agent, a solvent is added to prepare a positive electrode slurry. The slurry is applied to a current collector and dried to form a positive electrode layer. In this manner, a desired positive electrode is produced. The positive electrode containing LiCoO₂ as an active material is used as a working electrode and arranged within an outer package such that the positive electrode layer of the positive electrode faces a counter electrode formed of e.g., graphite, and a separator is interposed between the working electrode and the counter electrode. A reference electrode formed of a lithium metal is arranged above and in proximity to the working electrode, separator and counter electrode, within the outer package. Individual terminals of the working electrode, counter electrode and reference electrode are extended outside the package. The interior portion of the outer package was filled up with a non-aqueous electrolyte solution. In this manner, a cell is assembled. The cell is charged with a predetermined constant current up to a predetermined capacity in terms of the mass of the positive electrode active material. By the charging operation, lithium (Li) of the positive electrode active material (LiCoO₂) is ionized, passes through the separator and reaches the counter electrode. More specifically, Li of LiCoO₂ comes out. Thereafter, the cell is decomposed and the positive electrode containing Li₁₋ₓCoO₂ as the second active material is taken out. The positive electrode layer of the positive electrode is removed and crashed to obtain a mixture for the positive electrode containing Li₁₋ₓCoO₂ as the second active material.

In Form b), the first active material and second active material are a lithium-containing metal oxide or a lithium-containing metal phosphorus oxide mutually different in at least one element except lithium. In Form b), it is preferable that the plateau voltages of the first active material and second active material are mutually close. The phrase, “plateau voltages . . . mutually close” herein refers to voltages having a difference of 0.3 V or less.

More specifically, the first active material is a lithium-containing metal oxide or a lithium-containing metal phosphorus oxide having a stoichiometric composition; whereas, the second active material which is different from the first active material is a lithium-containing metal oxide or a lithium-containing metal phosphorus oxide having a composition of the stoichiometric composition minus lithium. To explain it by way of example, the first active material is lithium cobalt oxide (chemical formula: LiCoO₂); whereas, the second active material is a lithium nickel oxide (chemical formula: Li₁₋ₓNiO₂), where x represents the amount of lithium (Li) removed from the lithium nickel oxide; and x preferably ranges 0<x<0.5 and more preferably 0.1≤x≤0.4.

The second active material represented by chemical formula: Li₁₋ₓNiO₂ for used Form b) can be obtained in the same manner as in the second active material represented by chemical formula: Li₁₋ₓCoO₂.

The second active material is preferably contained in the positive electrode, more specifically, a positive-electrode active material, in a proportion of 2 mass % or more and 95 mass % or less relative to the total amount of the first active material and the second active material. If the second active material is contained in the proportion mentioned above in the positive-electrode active material, a sufficient amount of lithium can be released as a lithium ion from metal lithium of the negative electrode during the initial discharging. Because of this, lithium dendrite growth can be effectively suppressed or prevented in a long-term charge/discharge cycle by the function mentioned above and an internal short circuit accompanying with lithium dendrite growth can be prevented. Further, in a high energy density lithium secondary battery having a metal lithium negative electrode, the positive electrode can be maintained at a reaction potential (discharge average potential) at which the secondary battery is suitably used. The proportion of the second active material relative to the total amount of first active material and second active material is more preferably 5 mass % or more and 50 mass % or less, and further preferably 5 mass % or more and 20 mass % or less.

2) The first active material is a lithium-containing compound capable of intercalating and deintercalating lithium and the second active material is a compound containing no lithium and capable of intercalating and deintercalating lithium. Examples of compound containing no lithium include manganese dioxide or vanadium pentoxide.

More specifically, the first active material is a lithium-containing metal oxide or a lithium-containing metal phosphorus oxide mentioned above having a stoichiometric composition and the second active material is a compound containing no lithium such as an oxide. To explain by way of example, the first active material is lithium cobalt oxide (chemical formula: LiCoO₂); whereas, the second active material is manganese dioxide (chemical formula: MnO₂).

The second active material is preferably contained in a proportion of 5 mass % or more and 50 mass % or less relative to the total amount of first active material and second active material in the positive electrode, more specifically, in the positive-electrode active material. If the second active material is contained in the proportion mentioned above in the positive-electrode active material, a sufficient amount of lithium can be released as a lithium ion from metal lithium of the negative electrode during the initial discharging time. Because of this, lithium dendrite growth accompanying an internal short circuit in a long-term charge/discharge cycle can be effectively suppressed or prevented by the function mentioned above. Further, in a high energy density lithium secondary battery having a metal lithium negative electrode, the positive electrode can be maintained to have a reaction potential (discharge average potential) suitable for use in the secondary battery. The proportion of the second active material relative to the total amount of first active material and second active material is more preferably 5 mass % or more and 20 mass % or less, and further preferably 8 mass % or more and 15 mass % or less.

In the lithium secondary battery according to the embodiment, the second active material is involved in a charge-discharge reaction similarly to the first active material also after the initial discharge. Because of this, in Form 1) of Form 1) and 2) of positive-electrode active material, a lithium-containing metal oxide or a lithium-containing metal phosphate is used as the second active material. The lithium-containing metal oxide or lithium-containing metal phosphate is excellent in resistance to intercalation and deintercalation of lithium during the charge/discharging time (resistance to disintegration of a crystal structure), compared to a compound containing no lithium such as manganese dioxide used in Form 2) and thus can exhibit stable charge/discharge cycle characteristics for a long time.

The positive electrode layer may further contain a conductive material and a binding agent other than the positive-electrode active material.

The conductive material is not particularly limited, and a conductive material known in the art or commercially available one can be used. Examples of the conductive material include carbon black such as acetylene black and ketchen black, activated carbon and graphite.

The binding agent is not particularly limited, and a binding agent known in the art or commercially available one can be used. Examples of the binding agent include polyvinylidene fluoride (PVDF), polytetrafluoroethylene (PTFE), polyvinylpyrrolidone (PVP), polyvinylchloride (PVC), polyethylene (PE), polypropylene (PP), an ethylene-propylene copolymer, styrene butadiene rubber (SBR), polyvinyl alcohol (PVA) and carboxy methyl cellulose (CMC).

The blending proportions of the positive-electrode active material, conductive material and binding agent contained in a positive electrode layer relative to the total amount of these components are follows. Preferably, the proportion of the positive-electrode active material is 85 mass % or more and 98 mass % or less; the proportion of the conductive material is 1 mass % or more and 10 mass % or less; and the proportion of the binding agent is 1 mass % or more and 5 mass % or less.

<Negative Electrode>

The negative electrode has, for example, a negative electrode current collector, a lithium metal foil as a negative-electrode active material formed on one or both surfaces of the negative electrode current collector.

The negative electrode current collector is not particularly limited, and the collector known in the art or commercially available one can be used. For example, a rolled foil formed of copper or copper alloy and an electrolyte foil can be used.

<Separator>

The separator has a pore structure constituted of pores three-dimensionally arranged and connected via a bottleneck structure. More specifically, the separator has a bottleneck structure formed by connecting large macro-pores with small communication pores. The separator preferably has a porosity of 70% or more and 90% or less. In the case where the separator has the most orderly structure (close-packed structure), the porosity is 75% or more and 80% or less. The separator having such a structure and pores is referred to as a 3DOM separator. The 3DOM separator is a porous membrane formed of a fluororesin such as polytetrafluoroethylene or an engineering plastic such as polyimide.

The diameter of pores in the 3DOM separator is preferably 0.05 μm or more and 3 μm or less. If the pore diameter is set to fall within the range of 0.05 μm or more and 3 μm or less, it is possible to open micropores having an appropriate diameter in accordance with the range of the pore diameter in the metal lithium surface of the negative electrode at the initial discharge and lithium dendrite growth can be effectively suppressed or prevented when charge/discharge is repeated after the initial discharging. If the porosity is set to fall within the range of 70% or more and 90% or less, an appropriate amount of electrolyte solution can be held by the separator; and mechanical strength also can be maintained.

If a 3DOM separator having such a pore diameter and a porosity is used, more, smaller micropores having a predetermined depth can be opened regularly in the metal lithium surface of the negative electrode in the same fashion as in the pores three dimensionally and regularly arranged in the initial discharging time mentioned above. As a result, lithium dendrite growth and an internal short circuit between a positive electrode and a negative electrode which is caused by the lithium dendrite can be more securely prevented. More preferably, the pore diameter is 0.1 μm or more and 2 μm or less and the porosity is 75% or more and 80% or less.

The 3DOM separator has the following functions other than the aforementioned function during the initial discharge. (1) Since the 3DOM separator can be impregnated with a large amount of electrolyte solution, high ion conductivity can be obtained compared to a conventional separator. (2) Lithium ion can be sufficiently held and dispersed by the presence of fine pores uniformly arranged. (3) Distribution of current of a lithium ion can be equalized. As a result, a lithium secondary battery having high rate characteristics and excellent cycle characteristics can be obtained.

The 3DOM separator can be simply produced by a method using a monodispersed spherical inorganic fine particles as a template. Selecting the size of the monodispersed spherical inorganic fine particles serving as a template in production can easily control the diameter of pores in a porous membrane from a micro order to a nano-order. Controlling the calcination temperature and time of an aggregate of the monodispersed spherical inorganic fine particles can easily control the size of communication pores. In this manner, a 3DOM separator having desired characteristics can be easily produced.

The film thickness of the 3DOM separator, although it is not particularly limited, is preferably 20 to 500 μm.

<Electrolyte Solution>

The electrolyte solution (for example, non-aqueous electrolyte solution) contains a non-aqueous solvent and an electrolyte.

The non-aqueous solvent contains a cyclic carbonate and a linear carbonate as a main component. The cyclic carbonate is preferably at least one selected from ethylene carbonate (EC), propylene carbonate (PC) and butylene carbonate (BC). The linear carbonate is preferably at least one selected from e.g., dimethyl carbonate (DMC), diethyl carbonate (DEC) and ethyl methyl carbonate (EMC).

The electrolyte is not particularly limited, and a lithium salt electrolyte usually used in lithium secondary batteries can be used. For example, LiPF₆, LiAsF₆, LiBF₄, LiCF₃SO₃, LiN(CₘF₂ₘ₊₁SO₂) (CₙF2ₙ₊₁SO₂) (m and n are integers of 1 or more), LiC(CₚF₂ₚ₊₁SO₂) (C_{q}F_{2q+1}SO₂) (CᵣF₂ᵣ₊₁SO₂) (p, q and r are integers of 1 or more), lithium difluoro(oxalato)borate can be used. These electrolytes may be used alone or two types or more may be used in combination. The electrolyte is preferably dissolved in a non-aqueous solvent in a concentration as high as possible. However, in view of viscosity of the electrolyte solution and temperature characteristic of conductivity, it is desirable that the concentration of the electrolyte in a non-aqueous solvent is 0.1 to 1.5 mol/L and preferably 0.5 to 1.5 mol/L.

The shape of the lithium secondary battery according to the embodiment, although it is not particularly limited, is, for example, a coin form, a button form, a sheet form, a laminate form, a cylindrical form, a square shape and a flatted form.

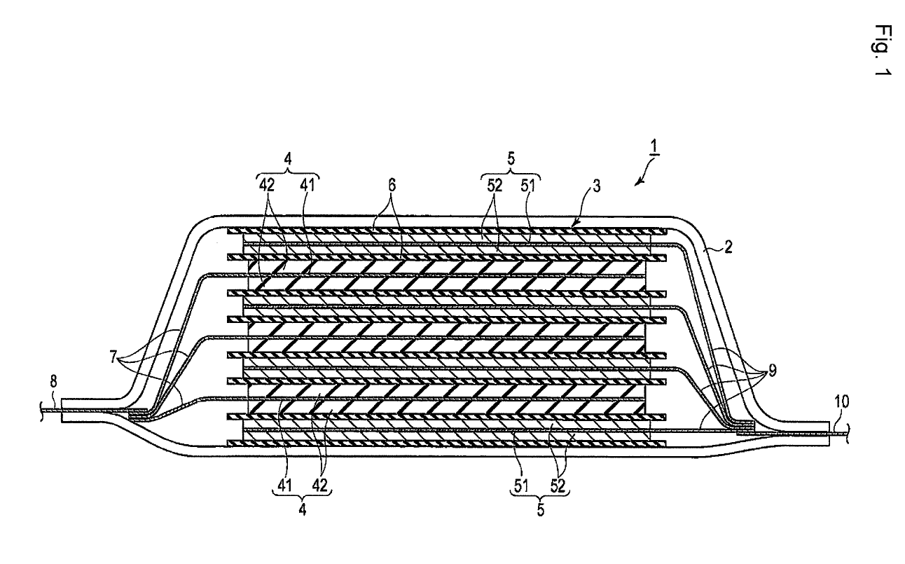

Now, referring to the accompanying drawing, the structure of the lithium secondary battery according to the embodiment will be described by way of a stacked lithium secondary battery. FIG. 1 is a sectional view of a stacked lithium secondary battery.

A stacked lithium secondary battery 1 has an outer package 2 like a bag formed of a laminate film. Within the outer package 2, a layered structure electrode group 3 is housed. The laminate film has a layered structure formed of multiple plastic-film sheets (for example, 2 sheets) having a metal foil such as an aluminum foil sandwiched between the films. As one of the two plastic films, a heat-fusible resin film is used. The outer package 2 is formed by laminating two laminate films such that the heat-fusible resin films mutually face. The electrode group 3 is housed between these laminate films and the two laminated films around the electrode group 3 are heat-sealed to seal them. In this manner, the electrode group 3 can be housed airtight.

The electrode group 3 is formed by laminating a plurality of structures, each of which consists of a positive electrode 4, a negative electrode 5 and a separator 6 interposed between the positive electrode 4 and the negative electrode 5 such that the negative electrode 5 is positioned as the outermost layer, and such that the separator 6 is positioned between the negative electrode 5 and the inner surface of the outer package 2. The positive electrode 4 is formed of a positive electrode current collector 41 and positive electrode layers 42, 42 formed on both surfaces of the current collector 41, respectively. The negative electrode 5 is formed of a negative electrode current collector 51 and negative electrode layers 52, 52 made of metal lithium and formed on both surfaces of the current collector 51, respectively.

Each positive electrode current collector 41 has a positive electrode lead 7 extending from, for example, the left-side surface of the positive electrode layer 42. Individual positive electrode leads 7 are bundled in a distal side within the outer package 2 and mutually bonded. One end of a positive electrode tab 8 is connected to the bonded portion of the positive electrode leads 7 and the other end thereof extends outside through a sealing part of the outer package 2. Each negative electrode current collector 51 has a negative electrode lead 9 extending from, for example, the right-side surface of the negative electrode layer 52. Individual negative electrode leads 9 are bundled in a distal side within the outer package 2 and mutually bonded. One end of a negative electrode tab 10 is connected to the bonded portion of the negative electrode leads 9 and the other end thereof extends outside through a sealing part of the outer package 2. The electrolyte solution is injected in the interior of the outer package 2. The injection site of the outer package is sealed after injection of the electrolyte solution.

### EXAMPLES

Now, Examples and Comparative Examples will be more specifically described. Note that, the present invention is not limited to the following Examples.

### Example 1

(Production of Positive Electrode)

A positive electrode slurry was prepared by stirring and kneading lithium iron phosphate of 85 mass % as a first active material and manganese dioxide of 4.5 mass % as a second active material, which serve as a positive-electrode active material; acetylene black of 6.1 mass % as a conductive material; a 40 mass % (solid concentration) acrylic copolymer solution of 2.7 mass % (in terms of solid content) as a binding agent; and a 2 mass % (solid concentration) aqueous carboxy methyl cellulose solution of 1.8 mass % (in terms of solid content) as a thickener, while adding an appropriate amount of ion exchanged water.

Subsequently, the positive electrode slurry was applied onto one of the surfaces of a current collector formed of aluminum foil and having a thickness of about 0.02 mm and dried at 70° C. for 10 minutes. Thereafter, the coating dried was pressed so as to obtain a density of 1.8 g/cc to form a positive electrode layer of the one of the surfaces of the current collector. In this manner, the positive electrode was produced.

(Assembly of Evaluation Cell)

The positive electrode obtained above was used as a working electrode and a 3-electrode evaluation cell was assembled. The evaluation cell has an outer package having a cylindrical shape with both ends closed and is formed of, for example, polypropylene. Within the outer package, a disc-form working electrode cut out from the positive electrode and a disk-form counter electrode larger in size than the working electrode are arranged such that the positive electrode layer of the positive electrode faces the counter electrode, and a separator is interposed between the working electrode and the counter electrode. The working electrode, separator and counter electrode are layered. The direction of layering is in parallel to the cylindrical part of the outer package. A reference electrode has a rectangular shape and arranged above and in proximity to the working electrode, separator and counter electrode within the outer package such that the rectangular plate surface comes in parallel to the layering direction. The terminals of each of the working electrode and counter electrode are expended outside from the opposite sealing parts of the outer package, separately. The terminals of the reference electrode are extended outside from the cylindrical part of the outer package. The interior of the outer package is filled with a non-aqueous electrolyte solution.

The counter electrode and reference electrode are formed of lithium metal. The separator is a 3DOM separator made of polyimide (the diameter of pores: about 0.3 μm, porosity: about 80%, film thickness: 50 μm). The electrolyte solution was prepared by dissolving LiPF₆ (1.3 mol/L) in a non-aqueous solvent mixture of ethylene carbonate (EC), dimethyl carbonate (DMC) and ethyl methyl carbonate (EMC) (volume ratio of EC:DMC:EMC=5:3:2). Note that, the evaluation cell was assembled in the glove box under an argon gas atmosphere.

### Example 2

A positive electrode was produced in the same manner as in Example 1 except that the positive electrode slurry prepared by the following method was used, and further an evaluation cell was assembled in the same manner as Example 1 using the positive electrode as a working electrode.

The positive electrode slurry was prepared by stirring and kneading lithium iron phosphate of 71.6 mass % as a first active material and manganese dioxide of 17.9 mass % as a second active material which serve as a positive-electrode active material; acetylene black of 6.1 mass % as a conductive material; a 40 mass % (solid concentration) acrylic copolymer solution of 2.7 mass % (in terms of solid content) as a binding agent; and a 2 mass % (solid concentration) aqueous carboxy methyl cellulose solution of 1.8 mass % (in terms of solid content) as a thickener, while adding an appropriate amount of ion exchanged water.

### Example 3

A positive electrode slurry was prepared by stirring and kneading lithium cobalt oxide of 85.5 mass % as first active material and manganese dioxide of 4.5 mass % as a second active material which serve as serving as a positive-electrode active material; acetylene black of 3 mass % and graphite of 3 mass % as a conductive material; and a 12 mass % (solid concentration) polyvinylidene fluoride solution of 4 mass % (in terms of solid content) as a binding agent, while adding an appropriate amount of N-methyl-2-pyrrolidone.

Subsequently, the positive electrode slurry was applied onto one of the surfaces of a current collector formed of aluminum foil and having a thickness of about 0.02 mm and dried at 100° C. for 10 minutes. Thereafter, the coating dried was pressed so as to obtain a density of 3.3 g/cc to form a positive electrode layer of the one of the surfaces of the current collector. In this manner, the positive electrode was produced. Further, an evaluation cell was assembled in the same manner as in Example 1 by using the positive electrode as a working electrode.

### Example 4

A positive electrode was produced in the same manner as in Example 3 except that the positive electrode slurry prepared by the following method was used, and further an evaluation cell was assembled in the same manner as Example 1 using the positive electrode as a working electrode.

The positive electrode slurry was prepared by stirring and kneading lithium cobalt oxide of 72 mass % as a first active material a first active material and manganese dioxide of 18 mass % as a second active material, which serve as a positive-electrode active material; acetylene black of 3 mass % and graphite of 3 mass % as a conductive material; and a 12 mass % (solid concentration) polyvinylidene fluoride solution of 4 mass % (in terms of solid content) as a binding agent, while adding an appropriate amount of N-methyl-2-pyrrolidone.

### Comparative Example 1

In assembling an evaluation cell in the same manner as in Example 1 using the same positive electrode as in Example 2, a stretched polyethylene film (porosity: about 40%) was used as a separator in place of a 3DOM separator made of polyimide.

### Comparative Example 2

In assembling an evaluation cell in the same manner as in Example 1 using the same positive electrode as in Example 4, a stretched polyethylene film (porosity: about 40%) was used as a separator in place of a 3DOM separator made of polyimide.

### Comparative Example 3

A positive electrode was produced in the same manner as in Example 1 except that a positive electrode slurry was prepared by stirring and kneading lithium iron phosphate of 89.4 mass % as a positive-electrode active material; acetylene black of 6.1 mass % as a conductive material; a 40 mass % (solid concentration) acrylic copolymer solution of 2.7 mass % (in terms of solid content) as a binding agent; and a 2 mass % (solid concentration) aqueous carboxy methyl cellulose solution of 1.8 mass % (in terms of solid content) as a thickener, while adding an appropriate amount of ion exchanged water. Further, an evaluation cell was assembled in the same manner as Example 1 using the positive electrode as a working electrode. More specifically, the separator of the evaluation cell is a 3DOM separator made of polyimide (diameter of pores: about 0.3ₚal, porosity: about 80%, film thickness: 50 μm).

(Electrochemical Test)

Charge/discharge performance was evaluated using the evaluation cells obtained in Examples 1 and 2 and Comparative Examples 1 and 3. A charge/discharge cycle test consisting sequentially of discharge at a current of 0.1 C up to 2.0 V, charge at a current of 0.2 C up to 4.2 V and discharge at a current of 0.2 C up to 2.0 V, was repeated 100 times.

Charge/discharge performance was evaluated using the evaluation cells obtained in Example 3 and 4 and Comparative Example 2. A charge/discharge cycle test consisting sequentially of discharge at a current of 0.1 C up to 2.0 V, charge at a current of 0.2 C up to 4.3 V and discharge at a current of 0.2 C up to 2.0 V, was repeated 100 times.

Note that the charge/discharge performance evaluation using the evaluation cells obtained in Examples 1 and 2 and Comparative Examples 1 and 3 and the charge/discharge performance evaluation using the evaluation cells obtained in Examples 3 and 4 and Comparative Example 2 are mutually different in that the voltage during the charging time is 4.2 V and 4.3 V, respectively.

In the charge/discharge performance evaluation, the initial discharge capacity, the 2nd cycle discharge capacity and the 100th cycle discharge capacity were measured. The results are shown in the following Table 1. In Table 1, “Proportion of second active material” refers to the proportion of a second active material relative to the total amount of the first active material and the second active material.

TABLE 1

| | Positive electrode active material | | | | | | |
|---|---|---|---|---|---|---|---|
| | | | Proportion of | | Initial | 2nd Cycle | 100th Cycle |
| | First | Second | second active | | discharge | discharge | discharge |
| | active | active | material | | capacity | capacity | capacity |
| | material | material | (mass %) | Separator | (mAh/g) | (mAh/g) | (mAh/g) |
| Example 1 | LiFePO₄ | MnO₂ | 5.02 | 3DOM | 10.2 | 168 | 131 |
| Example 2 | LiFePO₄ | MnO₂ | 20.00 | 3DOM | 43.0 | 169 | 136 |
| Example 3 | LiCoO₂ | MnO₂ | 5.02 | 3DOM | 9.6 | 160 | 118 |
| Example 4 | LiCoO₂ | MnO₂ | 20.00 | 3DOM | 43.5 | 162 | 130 |
| Comparative | LiFePO₄ | MnO₂ | 20.00 | Stretched PE | 43 | 168 | 91 |
| Example 1 | | | | | | | |
| Comparative | LiCoO₂ | MnO₂ | 20.00 | Stretched PE | 40.5 | 160 | — |
| Example 2 | | | | | | | |
| Comparative | LiFePO₄ | — | 0 | 3DOM | 0.6 | 165 | 62 |
| Example 3 | | | | | | | |

As clearly shown in Table 1, it is found that evaluation cells of Examples 1 to 4 using a positive-electrode active material consisting of LiFePO₄ or LiCoO₂ as a first active material and MnO₂ as a second active material and a 3DOM separator, have high discharge capacity even at the 100th cycle.

In contrast, it is found that, in evaluation cells of Comparative Examples 1 and 3, the capacity of the 100th cycle is significantly low compared to the evaluation cells of Examples 1 to 4. The capacity of the evaluation cell of Comparative Example 2 was not determined since an internal short circuit occurred.

More specifically, in the evaluation cells of Comparative Examples 1 and 2 using a separator formed of a stretched polyethylene film, since intercalation of lithium (reduced lithium deposition) was non-uniform by metal lithium of a negative electrode during the charging time, compared to the evaluation cells of Examples 1 to 4 using a 3DOM separator, lithium dendrite growth was promoted. In Comparative Example 1, a decrease in discharge capacity occurred in the 100 charge/discharge cycle. In Comparative Example 2, an internal short circuit occurred.

In the evaluation cell of Comparative Example 3 wherein a second active material (for example, MnO₂) capable of intercalating lithium in the battery reaction with a negative electrode immediately after assembly is not contained as a positive-electrode active material, since initial discharge cannot be performed and actually the cycle is started from charging. As a result, even if a 3DOM separator was used, lithium non-uniformly deposited on the metal lithium surface of the negative electrode during the charging time. Because of this, a decrease in discharge capacity occurred in the 100 charge/discharge cycle.

Thus, in evaluation cells of Examples 1 to 4, which uses a positive-electrode active material consisting of a first active material (LiFePO₄ or LiCoO₂) in a state under which lithium can be deintercalated in the battery reaction with a negative electrode immediately after assembly and a second active material (MnO₂) in a state under which lithium can be intercalated in the battery reaction with the negative electrode immediately after assembly; and a 3DOM separator, an effect beyond expectation, more specifically, a high discharge capacity even at the 100th cycle, can be obtained by synergistic work of them.

### Example 5

<Production of Positive Electrode Containing LiCoO₂ as First Active Material>

A positive electrode slurry was prepared by stirring and kneading LiCoO₂ of 90 mass % as a positive-electrode active material; acetylene black of 3 mass % and graphite of 3 mass % as a conductive material; and a 12 mass % (solid concentration) polyvinylidene fluoride solution of 4 mass % (in terms of solid content) as a binding agent, while adding an appropriate amount of N-methyl-2-pyrrolidone. Subsequently, the positive electrode slurry was applied onto one of the surfaces of a current collector formed of aluminum foil and having a thickness of about 0.02 mm and dried at 100° C. for 10 minutes. Thereafter, the coating dried was pressed so as to obtain a density of 3.3 g/cc to form a positive electrode layer of the one of the surfaces of the current collector. In this manner, the positive electrode containing LiCoO₂ as a first active material, was produced.

<Production of Positive Electrode Containing Li_{0.6}CoO₂ as Second Active Material>

A cell was constructed in the same manner as in Example 1 except that the positive electrode containing LiCoO₂ as a first active material was used as a working electrode and graphite was used as a counter electrode. The cell was charged with a constant current of 0.1 C up to a capacity of 110 mAh/g in terms of mass of the positive electrode active material. Thereafter, the cell was disassembled and the positive electrode containing Li_{0.6}CoO₂ as a second active material was taken out.

<Assembly of Evaluation Cell>

A positive electrode layer was removed from the positive electrode containing LiCoO₂ as a first active material and ground to obtain a mixture for the positive electrode layer containing LiCoO₂ as a first active material. Also, a positive electrode layer was removed from the positive electrode containing Li_{0.6}CoO₂ as a second active material and ground to obtain a mixture for the positive electrode layer containing Li_{0.6}CoO₂ as a second active material. Note that, the two mixtures for a positive electrode layer thus obtained contain an active material, a conductive material and a binding agent in the same mass proportion as in a case of preparation of the positive electrode containing LiCoO₂ as a first active material.

Then, the mixture for a positive electrode layer containing LiCoO₂ as a first active material and the mixture for a positive electrode layer containing Li_{0.6}CoO₂ as a second active material were mixed in a blending ratio of 9:1 to prepare a blend of the mixtures for a positive electrode layer. The blend of the mixtures was stirred while adding an appropriate amount of N-methyl-2-pyrrolidone to the blend and kneaded to prepare a positive electrode slurry. Subsequently, the positive electrode slurry was applied onto one of the surfaces of a current collector formed of aluminum foil and having a thickness of about 0.02 mm and dried at 100° C. for 10 minutes. Thereafter, the coating dried was pressed so as to obtain a density of 3.3 g/cc to form a positive electrode layer of the one of the surfaces of the current collector. In this manner, the positive electrode containing LiCoO₂ as a first active material and Li_{0.6}CoO₂ as a second active material was produced. An evaluation cell was assembled in the same manner as in Example 1 by using the positive electrode thus obtained as a working electrode.

### Example 6

A positive electrode was produced in the same manner as in Example 5 except that the mixture for a positive electrode layer obtained in Example 5 containing LiCoO₂ as a first active material and the mixture for a positive electrode layer containing Li_{0.6}CoO₂ as a second active material were mixed in a blending ratio of 7:3 to prepare a blend of the mixtures for a positive electrode layer. An evaluation cell was prepared in the same manner as in Example 1 using the positive electrode thus obtained as a working electrode.

### Example 7

<Production of Positive Electrode Containing LiMn₂O₄ as a First Active Material>

A positive electrode slurry was prepared by stirring and kneading LiMn₂O₄ of 90 mass % as a positive-electrode active material; acetylene black of 3 mass % and graphite of 3 mass % as a conductive material; and a 12 mass % (solid concentration) polyvinylidene fluoride solution of 4 mass % (in terms of solid content) as a binding agent, while adding an appropriate amount of N-methyl-2-pyrrolidone. Subsequently, the positive electrode slurry was applied onto one of the surfaces of a current collector formed of aluminum foil and having a thickness of about 0.02 mm and dried at 100° C. for 10 minutes. Thereafter, the coating dried was pressed so as to obtain a density of 2.8 g/cc to form a positive electrode layer of the one of the surfaces of the current collector. In this manner, the positive electrode containing LiMn₂O₄ as a first active material was produced.

<Production of Positive Electrode Containing Li_{0.2}Mn₂O₄ as a Second Active Material>

A cell was constructed in the same manner as in Example 1 except that the positive electrode containing LiMn₂O₄ as a first active material was used as a working electrode and graphite was used as a counter electrode. The cell was charged with a constant current of 0.1 C up to a capacity of 100 mAh/g in terms of mass of the positive electrode active material. Thereafter, the cell was disassembled and the positive electrode containing Li_{0.2}Mn₂O₄ as a second active material was taken out.

<Assembly of Evaluation Cell>

A positive electrode layer was removed from the positive electrode containing LiMn₂O₄ as a first active material and ground to obtain a mixture for the positive electrode layer containing LiMn₂O₄ as a first active material. Also, a positive electrode layer was removed from the positive electrode containing Li_{0.2}Mn₂O₄ as a second active material and ground to obtain a mixture for the positive electrode layer containing Li_{0.2}Mn₂O₄ as a second active material. Note that, the two mixtures for a positive electrode layer contain an active material, a conductive material and a binding agent in the same mass proportion as in a case of preparation of the positive electrode containing LiMn₂O₄ as a first active material.

Then, the mixture for a positive electrode layer containing LiMn₂O₄ as a first active material and the mixture for a positive electrode layer containing Li_{0.2}Mn₂O₄ as a second active material were mixed in a blending ratio of 9:1 to prepare a blend of the mixtures for a positive electrode layer. The blend of the mixtures was stirred while adding an appropriate amount of N-methyl-2-pyrrolidone to the blend and kneaded to prepare a positive electrode slurry. Subsequently, the positive electrode slurry was applied onto one of the surfaces of a current collector formed of aluminum foil and having a thickness of about 0.02 mm and dried at 100° C. for 10 minutes. Thereafter, the coating dried was pressed so as to obtain a density of 3.3 g/cc to form a positive electrode layer of the one of the surfaces of the current collector. In this manner, the positive electrode containing LiMn₂O₄ as a first active material and Li_{0.2}Mn₂O₄ as a second active material was produced. An evaluation cell was assembled in the same manner as in Example 1 by using the positive electrode thus obtained as a working electrode.

### Example 8

A positive electrode was produced in the same manner as in Example 7 except that the mixture for a positive electrode layer obtained in Example 7 containing LiMn₂O₄ as a first active material and the mixture for a positive electrode layer containing Li_{0.2}Mn₂O₄ as a second active material were mixed in a blending ratio of 7:3 to prepare a blend of the mixtures for a positive electrode layer. An evaluation cell was assembled in the same manner as in Example 1 using the positive electrode thus obtained as a working electrode.

### Example 9

A positive electrode was produced in the same manner as in Example 5 except that the mixture for a positive electrode layer obtained in Example 5 containing LiCoO₂ as a first active material and the mixture for a positive electrode layer obtained in Example 7 containing Li_{0.2}Mn₂O₄ as a second active material were mixed in a blending ratio of 9:1 to prepare a blend of the mixtures for a positive electrode layer. Note that, the two mixtures for a positive electrode layer contain an active material, a conductive material and a binding agent in the same mass ratio. Thereafter, an evaluation cell was assembled in the same manner as Example 1 using the positive electrode thus obtained as a working electrode.

### Example 10

A positive electrode was produced in the same manner as in Example 5 except that the mixture for a positive electrode layer obtained in Example 5 containing LiCoO₂ as a first active material and the mixture for a positive electrode layer obtained in Example 7 containing Li_{0.2}Mn₂O₄ as a second active material were mixed in a mass ratio of 7:3 to prepare a blend of mixtures for a positive electrode layer. Further, an evaluation cell was assembled in the same manner as Example 1 using the positive electrode thus obtained as a working electrode.

### Example 11

A positive electrode slurry was prepared by stirring and kneading LiNi_{0.5}Co_{0.2}Mn_{0.3}O₂ of 92 mass % as a positive-electrode active material; acetylene black of 2.5 mass % and graphite of 2.5 mass % as a conductive material; and a 12 mass % (solid concentration) polyvinylidene fluoride solution of 3 mass % (in terms of solid content) as a binding agent, while adding an appropriate amount of N-methyl-2-pyrrolidone. Subsequently, the positive electrode slurry was applied onto one of the surfaces of a current collector formed of aluminum foil and having a thickness of about 0.02 mm and dried at 100° C. for 10 minutes. Thereafter, the coating dried was pressed so as to obtain a density of 2.5 g/cc to form a positive electrode layer of the one of the surfaces of the current collector. In this manner, the positive electrode containing LiNi_{0.5}Co_{0.2}Mn_{0.3}O₂ as a first active material was prepared.

A positive electrode layer was removed from the positive electrode containing LiNi_{0.5}Co_{0.2}Mn_{0.3}O₂ as a first active material and ground to obtain a mixture for the positive electrode layer containing LiNi_{0.5}Co_{0.2}Mn_{0.3}O₂ as a first active material.

Then, a positive electrode was produced in the same manner as in Example 5 except that the mixture for a positive electrode layer containing LiNi_{0.5}Co_{0.2}Mn_{0.3}O₂ as a first active material and the mixture for a positive electrode layer containing Li_{0.6}CoO₂ as a second active material obtained in Example 5 were mixed in a blending ratio of 9:1 to prepare a blend of the mixtures for a positive electrode layer. Further, an evaluation cell was assembled in the same manner as Example 1 using the positive electrode thus obtained as a working electrode.

### Example 12

A positive electrode was produced in the same manner as in Example 5 except that the mixture for a positive electrode layer obtained Example 11 containing LiNi_{0.5}Co_{0.2}Mn_{0.3}O₂ as a first active material and the mixture for a positive electrode layer obtained in Example 5 containing Li_{0.6}CoO₂ as a second active material were mixed in a mass ratio of 7:3 to prepare a blend of the mixtures for a positive electrode layer. Further, an evaluation cell was assembled in the same manner as Example 1 using the positive electrode thus obtained as a working electrode.

Charge/discharge performance was evaluated using the evaluation cells obtained in Examples 5 to 12. A charge/discharge cycle test consisting sequentially of discharge at a current of 0.1 C up to 2.0 V, charge at a current of 0.2 C up to 4.3 V and discharge at a current of 0.2 C up to 2.0 V, was repeated 100 times.

In the charge/discharge performance evaluation, the initial discharge capacity, the 2nd cycle discharge capacity and the 100th cycle discharge capacity were measured. The results are shown in the following Table 2. In Table 2, “Proportion of second active material” refers to the proportion of a second active material relative to the total amount of the first active material and the second active material.

TABLE 2

| | Positive electrode active material | | | | | | |
|---|---|---|---|---|---|---|---|
| | | | Proportion of | | Initial | 2nd Cycle | 100th Cycle |
| | First | Second | second active | | discharge | discharge | discharge |
| | active | active | material | 3DOM | capacity | capacity | capacity |
| | material | material | (mass %) | Separator | (mAh/g) | (mAh/g) | (mAh/g) |
| Example 5 | LiCoO₂ | Li_{0.6}CoO₂ | 10.00 | Same as in | 9.9 | 152 | 136 |
| | | | | Example 1 | | | |
| Example 6 | LiCoO₂ | Li_{0.6}CoO₂ | 30.00 | Same as in | 29.1 | 153 | 143 |
| | | | | Example 1 | | | |
| Example 7 | LiMn₂O₄ | Li_{0.2}Mn₂O₄ | 10.00 | Same as in | 10.2 | 122 | 107 |
| | | | | Example 1 | | | |
| Example 8 | LiMn₂O₄ | Li_{0.2}Mn₂O₄ | 30.00 | Same as in | 29.8 | 122 | 110 |
| | | | | Example 1 | | | |
| Example 9 | LiCoO₂ | Li_{0.2}Mn₂O₄ | 10.00 | Same as in | 10.0 | 145 | 126 |
| | | | | Example 1 | | | |
| Example 10 | LiCoO₂ | Li_{0.2}Mn₂O₄ | 30.00 | Same as in | 30.1 | 140 | 126 |
| | | | | Example 1 | | | |
| Example 11 | LiNi_{0.5}Co_{0.2}Mn_{0.3}O₂ | Li_{0.6}CoO₂ | 10.00 | Same as in | 9.2 | 154 | 141 |
| | | | | Example 1 | | | |
| Example 12 | LiNi_{0.5}Co_{0.2}Mn_{0.3}O₂ | Li_{0.6}CoO₂ | 30.00 | Same as in | 29.0 | 152 | 143 |
| | | | | Example 1 | | | |

As clearly shown in Table 2, it is found that the evaluation cells of Examples 5 to 8 using a positive-electrode active material consisting of a first active material, which is a lithium containing metal oxide having the same constitutional elements as in a second active material and a stoichiometric composition; and a second active material, which is a lithium containing metal oxide having a composition of the stoichiometric composition minus lithium and using a 3DOM separator, have a high discharge capacity even at the 100th cycle.

In addition, it is found in that the evaluation cells of Examples 9 to 12 using a positive-electrode active material consisting of a first active material, which is a lithium containing metal oxide different in at least one metal element except lithium from a second active material and having a stoichiometric composition; and a second active material, which is a lithium containing metal oxide having a composition of the stoichiometric composition minus lithium and using a 3DOM separator, have a high discharge capacity even at the 100th cycle.

### Example 13

An evaluation cell was assembled in the same manner as in Example 1 except that the positive electrode obtained in Example 2 and a 3DOM separator made of polyimide having a pore diameter of about 0.1 μm, a porosity of about 80% and a film thickness of 50 μm were used.

### Example 14

An evaluation cell was assembled in the same manner as in Example 1 except that the positive electrode obtained in Example 2 and a 3DOM separator made of polyimide having a pore diameter of about 0.5 μm, a porosity of about 80% and a film thickness of 50 μm were used.

### Example 15

An evaluation cell was assembled in the same manner as in Example 1, except that the positive electrode obtained in Example 2 and a 3DOM separator made of polyimide having a pore diameter of about 1 μm, a porosity of about 80% and a film thickness of 50 μm were used.

### Example 16

An evaluation cell was assembled in the same manner as in Example 1, except that the positive electrode obtained in Example 2 and a 3DOM separator made of polyimide having a pore diameter of about 3 μm, a porosity of about 80% and a film thickness of 50 μm were used.

### Example 17

An evaluation cell was assembled in the same manner as in Example 1, except that the positive electrode obtained in Example 5 and a 3DOM separator made of polyimide having a pore diameter of about 0.1 μm, a porosity of about 80% and a film thickness of 50 μm were used.

### Example 18

An evaluation cell was assembled in the same manner as in Example 1, except that the positive electrode obtained in Example 5 and a 3DOM separator made of polyimide having a pore diameter of about 0.5 μm, a porosity of about 80% and a film thickness of 50 μm were used.

### Example 19

An evaluation cell was assembled in the same manner as in Example 1, except that the positive electrode obtained in Example 5 and a 3DOM separator made of polyimide having a pore diameter of about 1 μm, a porosity of about 80% and a film thickness of 50 μm were used.

### Example 20

An evaluation cell was assembled in the same manner as in Example 1, except that the positive electrode obtained in Example 5 and a 3DOM separator made of polyimide having a pore diameter of about 3 μm, a porosity of about 80% and a film thickness of 50 μm were used.

Charge/discharge performance evaluation using the evaluation cells obtained in Examples 13 to 20 was performed by repeating a charge/discharge cycle test consisting sequentially of discharge at a current of 0.1 C up to 2.0 V, charge at a current of 0.2 C up to 4.3 V and discharge at a current of 0.2 C up to 2.0 V was repeated 100 times.

In the charge/discharge performance evaluation, the initial discharge capacity, the 2nd cycle discharge capacity and the 100th cycle discharge capacity were measured. The results are shown in the following Table 3. In Table 3, “Proportion of second active material” refers to the proportion of a second active material relative to the total amount of the first active material and the second active material.

TABLE 3

| | Positive electrode active material | | | | | | | | |
|---|---|---|---|---|---|---|---|---|---|
| | | | Proportion of | 3DOM Separator | | | Initial | 2nd Cycle | 100th Cycle |
| | First | Second | second active | Pore | | Film | discharge | discharge | discharge |
| | active | active | material | diameter | Porosity | thickness | capacity | capacity | capacity |
| | material | material | (mass %) | (μm) | (%) | (μm) | (mAh/g) | (mAh/g) | (mAh/g) |
| Example 13 | LiFePO₄ | MnO₂ | 20.00 | 0.1 | 80 | 50 | 42.1 | 168 | 129 |
| Example 14 | LiFePO₄ | MnO₂ | 20.00 | 0.5 | 80 | 50 | 43.0 | 166 | 135 |
| Example 15 | LiFePO₄ | MnO₂ | 20.00 | 1.0 | 80 | 50 | 42.8 | 165 | 133 |
| Example 16 | LiFePO₄ | MnO₂ | 20.00 | 3.0 | 80 | 50 | 44.1 | 170 | 133 |
| Example 17 | LiCoO₂ | Li_{0.6}CoO₂ | 20.00 | 0.1 | 80 | 50 | 20.3 | 153 | 132 |
| Example 18 | LiCoO₂ | Li_{0.6}CoO₂ | 20.00 | 0.5 | 80 | 50 | 19.9 | 150 | 137 |
| Example 19 | LiCoO₂ | Li_{0.6}CoO₂ | 20.00 | 1.0 | 80 | 50 | 19.7 | 153 | 139 |
| Example 20 | LiCoO₂ | Li_{0.6}CoO₂ | 20.00 | 3.0 | 80 | 50 | 19.6 | 151 | 133 |

As clearly shown in Table 3, it is found that evaluation cells of Examples 13 to 16, which use a positive-electrode active material same as in Example 2, and a 3DOM separator having the same porosity (80%) and film thickness (50 μm), and a different pore diameter within the range of 0.1 to 3.0 μm; and even evaluation cells of Examples 17 to 20, which use a positive-electrode active material same as in Example 5, and a 3DOM separator having the same porosity (80%) and film thickness (50 μm) and a different pore diameter within the range of 0.1 to 3.0 μm, have a high discharge capacity even at the 100th cycle.

### INDUSTRIAL APPLICABILITY

According to the present invention, it is possible to provide a highly reliable and high-performance lithium secondary battery, which suppresses or prevents lithium dendrite growth; has high capacity and excellent charge/discharge cycle characteristics and suitably used for a power source for hybrid cars or electric cars and a power storage source for natural energy such as sun light and wind power.

1. A lithium secondary battery comprising a positive electrode, a negative electrode, a separator and an electrolyte solution, wherein
the positive electrode contains a first active material and a second active material each capable of intercalating and deintercalating lithium, the first active material being in the state under which only deintercalation of lithium can be carried out in a battery reaction with the negative electrode immediately after assembly of the lithium secondary battery, and the second active material being in the state under which lithium can be intercalated in the battery reaction with the negative electrode immediately after assembly of the lithium secondary battery,
the negative electrode contains metal lithium as an active material, and
the separator has a structure in which pores are three-dimensionally regularly arranged.

2. The lithium secondary battery according to claim 1, wherein the first active material and the second active material are lithium-containing compounds, the first active material is a lithium-containing compound which can carry out only deintercalation of lithium in a battery reaction with the negative electrode immediately after assembly of the lithium secondary battery, and the second active material is a lithium-containing compound from which lithium is partly removed and which can intercalate lithium in a battery reaction with the negative electrode immediately after assembly of the lithium secondary battery.

3. The lithium secondary battery according to claim 2, wherein the lithium-containing compounds of the first active material and the second active material have the same elements constituting the lithium-containing compounds.

4. The lithium secondary battery according to claim 2, wherein the lithium-containing compounds of the first active material and the second active material differ in at least one metal element except lithium of the elements constituting the lithium-containing compounds.

5. The lithium secondary battery according to claim 2, wherein the lithium-containing compound is a lithium-containing metal oxide or a lithium-containing metal phosphate.

6. The lithium secondary battery according to claim 2, wherein the second active material is contained in the positive electrode in a proportion of 2 mass % or more and 95 mass % or less relative to the total amount of the first active material and the second active material.

7. The lithium secondary battery according to claim 1, wherein the first active material is a lithium-containing compound and the second active material is a compound containing no lithium.

8. The lithium secondary battery according to claim 7, wherein the lithium-containing compound is a lithium-containing metal oxide or a lithium-containing metal phosphate and the compound containing no lithium is manganese dioxide or vanadium pentoxide.

9. The lithium secondary battery according to claim 7 wherein the second active material is contained in the positive electrode in a proportion of 5 mass % or more and 50 mass % or less relative to the total amount of the first active material and the second active material.

10. The lithium secondary battery according to claim 1, wherein the separator has the pores communicating with each other and having a diameter of 0.05 μm or more and 3 μm or less, and has a porosity of 70% or more and 90% or less.
